(19) United States
(12) Patent Application Publication
(10) Pub. No.: US 2024/0308256 A1
(43) Pub. Date: Sep. 19, 2024

(54) RIBBON CONTROL IN INDIRECT THERMAL PRINTING

(71) Applicant: TOSHIBA TEC KABUSHIKI KAISHA, Tokyo (JP)

(72) Inventors: Michael W. Lawrence, Lexington, KY (US); George N. Woolcott, Lancaster, KY (US); Brad W. Towe, Versailles, KY (US)

(21) Appl. No.: 18/122,623

(22) Filed: Mar. 16, 2023

(51) Int. Cl. B41J 35/08; B41J 2/325; B41J 3/407; B41J 31/05; B41J 33/26; B41J 35/20

(52) U.S. Cl. CPC B41J 35/08; B41J 2/325; B41J 3/4075; B41J 31/05; B41J 33/26; B41J 35/20

(57) ABSTRACT

A pulse width modulation (PWM) system functions such that while label paper is moving into position, ribbon motors have power applied to maintain tension in the ribbon to avoid any contact with the adhesive. Once the label paper stops and is in position the power to the ribbon motors are cut to allow slack in the ribbon and a printhead solenoid actuates at full power to lift. Once lifted the solenoid cuts back to partial power to hold position and the ribbon motors are powered again. Thus, ribbon motor power is adjusted to allow the solenoid to lift without additional resistance.

### TECHNICAL FIELD

This application relates generally to a label printing system. The application relates more particularly to controlling ribbon tension during indirect thermal label printing.

### BACKGROUND

Label printers typically print indicia, such as mailing addresses, onto a label that has adhesive on one side. The adhesive is generally covered with a release paper, or liner, that is removed prior to the label being placed onto the desired object, such as a letter or a box for shipping. Label printing may be done conventionally, such as with a printhead for deposition of toner or ink. Label printing may also be done by thermal printing.

There are two basic systems for thermal printing, direct thermal and thermal transfer. Both systems use a thermal printhead to an image receiving surface. Direct thermal printing uses chemically treated, heat-sensitive media that blackens when it passes under the thermal printhead. Thermal transfer or indirect printing uses a heated ribbon to produce durable, long-lasting images on a wide variety of materials.

Direct thermal printing is simple, but bears disadvantages. A label printed on thermal paper can discolor when exposed to sufficient heat, obliterating all or some of the printed content. Thermal transfer printing is not so affected, and generally provides a cleaner image.

### BRIEF DESCRIPTION OF THE DRAWINGS

Various embodiments will become better understood with regard to the following description, appended claims and accompanying drawings wherein:

FIG. 1A is a first view of an example embodiment of a thermal printing system;

FIG. 1B is a second view of an example embodiment of a thermal printing system;

FIG. 2 illustrates an example embodiment of an indirect thermal printer;

FIG. 3 illustrates an example embodiment of pulse width modulation (PWM)

control of a ribbon supply;

FIG. 4 is a schematic diagram of an in-line dual-sided thermal printing system; and

FIG. 5 is a schematic example embodiment of a PWM generator operable in conjunction with microcontroller, suitably programmed to generate the waveforms of FIG. 3.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Dual sided label printing allows for providing information, such as shipping address on a top side of a label. Additional information, such as a packing list or a return label, can be printed on the reverse side, saving printing and media costs. Commercially available dual sided label printers include models such as the BA410T series and BA420T series offered by Toshiba TEC. These models provide direct thermal printing on one side of a label and indirect or thermal transfer printing on the other side.

Example embodiments herein are directed to label printers that print dual sided labels from thermally reactive label stock removed from a spool or fanfold media. The label stock has a non-adhesive side and a partial adhesive side comprised of adhesive areas and non-adhesive print areas. The label stock includes a direct or contact thermal printer for printing on the non-adhesive side of the label stock and a thermal transfer printer for printing on the non-adhesive print areas.

Great care must be taken when using a print ribbon that is proximate to an adhesive side of the label stock. Any contact of the transfer ribbon to an adhesive portion could quickly de-spool transfer ribbon and cause for jamming and damage to the printer.

Example embodiments herein relate to controlling ribbon tension and payout in a thermal transfer system with a solenoid actuated printhead. Due to the nature of the exposed adhesive used in combination with a thermal transfer printer, such as a resin based transfer system, tension is critical to avoid being caught by the adhesive. Additionally a long stroke is required to avoid touching the adhesive with the ribbon. This can be very demanding for a solenoid actuated system. If ribbon tension is too high the device cannot product enough force to overcome lifting and compressing the spring force needed to print. Example embodiments minimize the load on the lift mechanism at the start of the lift cycle due to the nature of solenoids low pull force at start of cycle.

A pulse width modulation (PWM) system functions such that while the paper is moving into position, ribbon motors have power applied to maintain tension in the ribbon to avoid any contact with the adhesive. However this applied power may be too much for the solenoid to overcome. Once the paper stops and is in position the power to the ribbon motors are cut to allow slack in the ribbon and the printhead solenoid actuates at full power to lift. Once lifted the solenoid cuts back to partial power to hold position and the ribbon motors are powered again. Thus, ribbon motor power adjusted to allow the solenoid to lift without additional resistance.

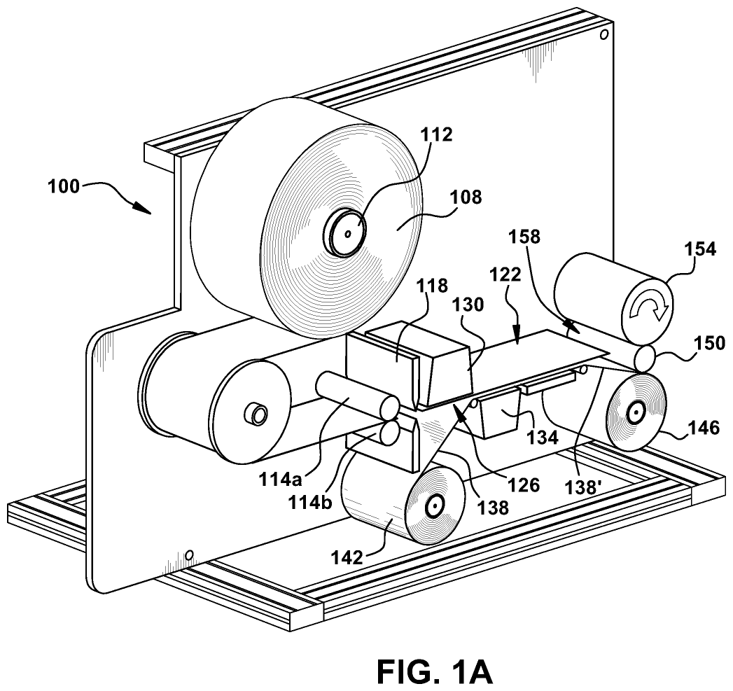

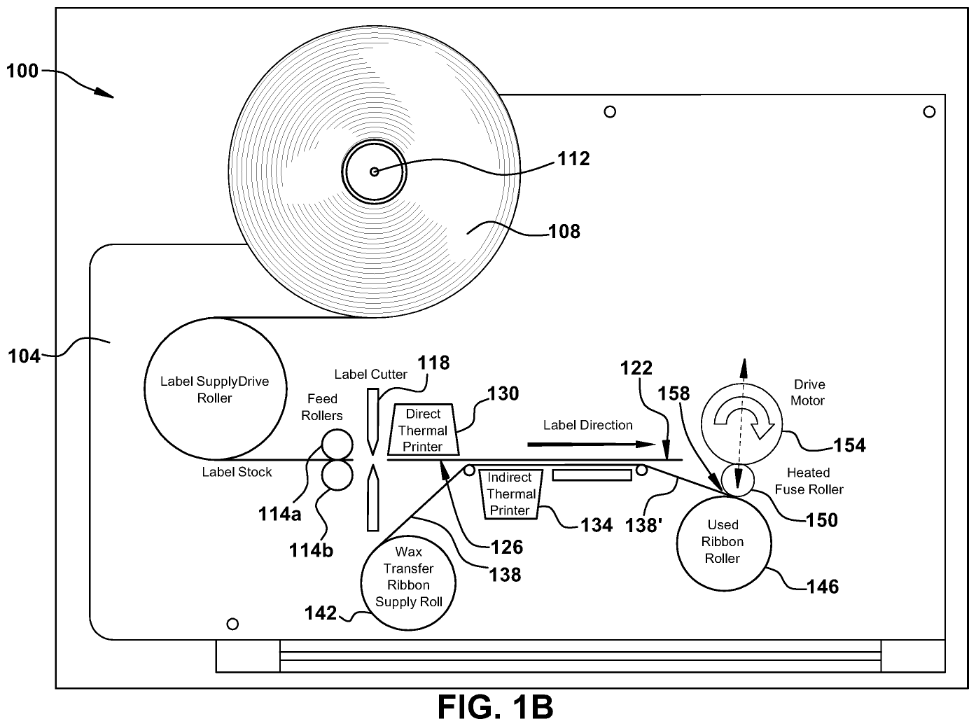

In accordance with the subject application, FIGS. 1A and 1B illustrate an example embodiment of a label printing system 100. The print system 100 includes a transfer label supply roller 104 that receives thermal print media 108 from label supply roll 112. Thermal pring media 108 is removed by cooperative feed rollers 114a and 114b. Labels are separated by label cutter 118 for printing. In the illustrated example, thermal printing can be accomplished on both sides of label stock. Direct thermal printing cannot be used on both sides insofar as, if attempted, the front and back images would intermesh due to application of first and second thermal printheads to opposing sides of the same media. This is avoided by use of direct thermal printing on a top side 122 of thermal print media 108 and thermal transfer printing on bottom side 126. Direct thermal printer 130 provides an image to top side 122 while indirect thermal printer 134 transfers an image to the bottom side 126 by application of heat to transfer ribbon 138 received from supply roll 142. After printing, exposed transfer ribbon 138′ is wound onto used ribbon roller 146.

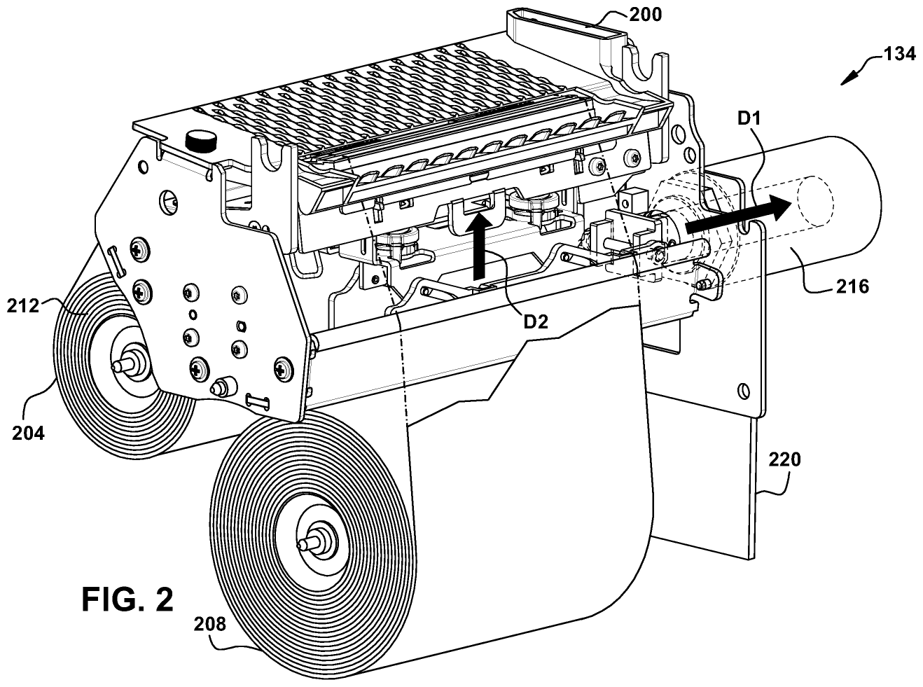

FIG. 2 illustrates an example embodiment of an indirect thermal printer 134 of FIG. 1. Included is printhead 200, a transfer ribbon supply roll 204 and a take up roll 208. Thermal transfer ribbon 212 is removed from ribbon supply roll 204 and moved to be proximate to printhead 200 which is disposed along an adhesive side of unlined label stock. When a label is in a position where non-adhesive area is disposed above the printhead, advancement of the label stock and print ribbon is stopped and printhead 200 lifts to contact the ribbon to the label stock. This is accomplished by activation of solenoid 216 in direction D1 which, in turn, causes movement of printhead 200 in direction D2. Rotation of ribbon supply roll 204, take up roll 208 and printhead 200 are controlled by application of pulse width modulated signals to corresponding drive motors, such as take up roll drive motor 220.

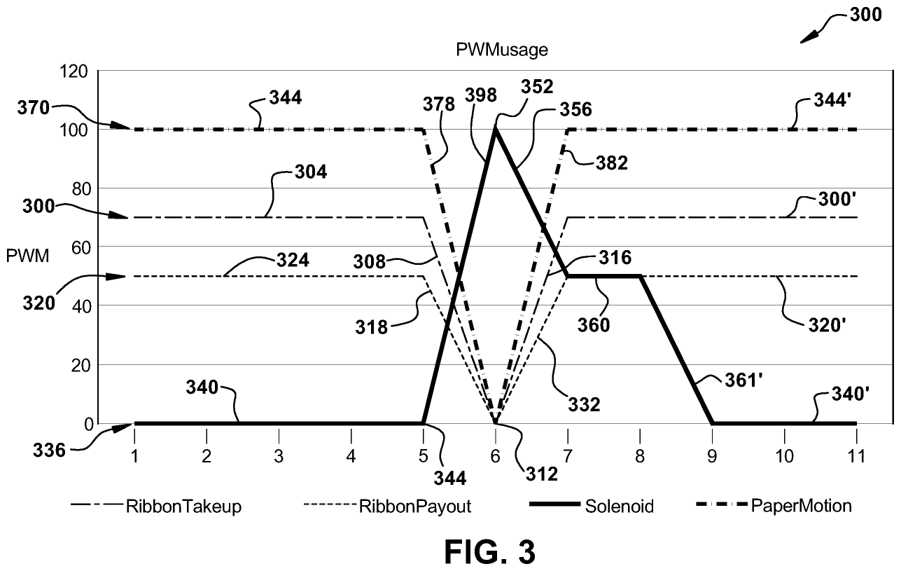

FIG. 3 illustrates an example embodiment 300 of PWM control of ribbon supply, ribbon take up and printhead movement as detailed above. Ribbon take up control signal 300 causes constant motion of the take up roller at PWM level 304, deceleration at 308, stoppage at 312, acceleration at 16 and return to constant motion at 300′. Analogously, ribbon payout control signal 320 causes constant motion of the take up roller at PWM level 324, deceleration at 328, stoppage at 312, acceleration at 332 and return to constant motion at 300′. Solenoid control signal 336 has an inactivated solenoid at 340 with activation occurring at 344. Activation results in acceleration 398, followed by deactivation 352 following a print, which results in a deceleration interval 356 with an intermediate pause at 360. This is followed by continued deceleration at 361′ and a return to inactivation 340′. Paper movement 370 has label stock in motion at 344, deceleration 378, stoppage for printing at 312, acceleration at 382 and return to motion at 344′.

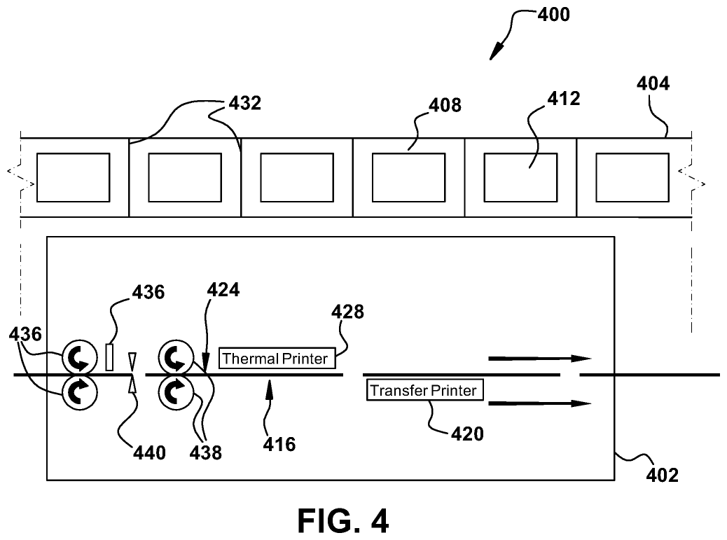

FIG. 4 is a schematic diagram 400 of an in-line dual-sided thermal printer 402 for printing on a web 404 of unlined label stock. The label stock includes a gummed, adhesive portion 408 that defines a sequence of rectangular, non-gummed print areas 412 for indirect thermal printing on adhesive side 416 by transfer printer 420. Printing on non-adhesive side 424 is accomplished with direct contact thermal printer 428. Label position is tracked by separator lines 432 on web 404, which lines are sensed by line sensor 436. Label positioning is suitably controlled by one or more pairs of cooperative rollers such as roller pair 438. Individual labels are formed by label cutter 440.

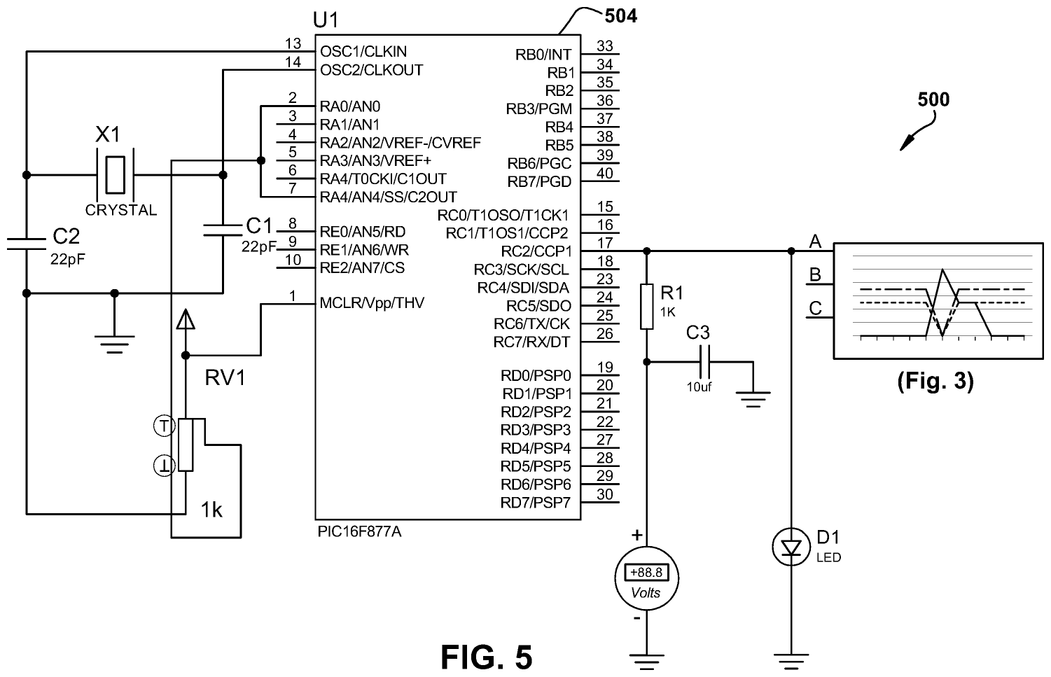

FIG. 5 is an example embodiment of a PWM generator 500 operable in conjunction with microcontroller 504, suitably programmed to generate the waveforms of FIG. 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a transfer ribbon supply roll configured to feed heat activated transfer ribbon to a thermal transfer printhead of a thermal transfer printer;
a solenoid configured to cause the printhead to contact the transfer ribbon during each of a sequence of prints and retract the printhead from the transfer ribbon after completion of each print, the solenoid configured to operate in accordance with a first pulse width modulation signal;
a drive system configured to move the transfer ribbon through the thermal transfer printer, the drive system including a ribbon payout drive configured to rotate the transfer ribbon supply roll in accordance with a second pulse width modulation signal and a ribbon take up drive configured to control rotation of an exposed ribbon take up roll in accordance with a third pulse width modulation signal; and
a pulse width modulation generator configured to generate the first, second and third pulse width modulation signals such that the transfer ribbon is under tension between prints and slackened during each print.

2. The system of claim 1 wherein the pulse width modulation generator is further configured to generate the first, second and third pulse width modulation signals such that the transfer ribbon is stationary during each print.

3. The system of claim 2 wherein the pulse width modulation generator is further configured to generate the first, second and third pulse width modulation signals such that the printhead is partially retracted during an acceleration of the supply roll and the take up roll after completion of each print and fully retracted when the acceleration is stopped.

4. The system of claim 2 further comprising a label stock supply roll configured to supply a web of label stock comprising linerless adhesive labels to the thermal transfer printer such that an exposed partially adhesive side is proximate to the transfer ribbon.

5. The system of claim 3 wherein the web of label stock is stationary during each print to print area of the web of label stock having no adhesive while the ribbon is slackened.

6. The system of claim 5 wherein the web of label stock is in motion relative to the print ribbon between prints while the ribbon is under tension.

7. The system of claim 6 wherein the print area is a rectangular area defined by the adhesive.

8. A method comprising:
feeding heat activated transfer ribbon to a thermal transfer printhead of a thermal transfer printer;
engaging a solenoid to cause the printhead to contact the transfer ribbon during each of a sequence of prints and retract the printhead from the transfer ribbon after completion of each print, the solenoid configured to operate in accordance with a first pulse width modulation signal;
rotating the transfer ribbon supply roll in accordance with a second pulse width modulation signal;
rotating an exposed ribbon take up roll in accordance with a third pulse width modulation signal; and
generating the first, second and third pulse width modulation signals such that the transfer ribbon is under tension between prints and slackened during each print.

9. The method of claim 8 further comprising generating the first, second and third pulse width modulation signals such that the transfer ribbon is stationary during each print.

10. The method of claim 9 further comprising generating the first, second and third pulse width modulation signals such that the printhead is partially retracted during an acceleration of the supply roll and the take up roll after completion of each print and fully retracted when the acceleration is stopped.

11. The method of claim 9 further comprising supplying a web of linerless adhesive labels to the thermal transfer printer such that an exposed partially adhesive side is proximate to the transfer ribbon.

12. The method of claim 10 wherein the web of linerless adhesive labels is stationary during each print to a print area having no adhesive while the ribbon is slackened.

13. The method of claim 12 wherein the web of linerless adhesive labels is in motion relative to the print ribbon between prints while the ribbon is under tension.

14. The method of claim 13 wherein the print area is a rectangular area defined by the adhesive.

15. A dual-sided inline label printer comprising:
a label supply roll comprising a web of thermally sensitive label stock having a non-adhesive side and a partial adhesive side including a sequence of print areas devoid of and surrounded by adhesive;
a contact thermal printer configured to print a sequence of label images on the non-adhesive side;
an indirect thermal printer having a solenoid, the solenoid actuating a printhead disposed on the partial adhesive side, the solenoid configured to cause the printhead to contact the transfer ribbon to print an image on each print area and retract the printhead from the transfer ribbon after completion of each printed image, the solenoid configured to operate in accordance with a first pulse width modulation signal;
a transfer ribbon supply roll comprising a web of thermally sensitive transfer ribbon;
a drive system configured to move the transfer ribbon from the transfer ribbon supply roll to the printhead then to an exposed ribbon take up roll, the drive system including a ribbon payout drive configured to rotate the transfer ribbon supply roll in accordance with a second pulse width modulation signal and a ribbon take up drive configured to control rotation of the exposed ribbon take up roll in accordance with a third pulse width modulation signal; and
a pulse width modulation generator configured to generate the first, second and third pulse width modulation signals such that the transfer ribbon is under tension between prints and slackened during each print.

16. The system of claim 15 wherein the pulse width modulation generator is further configured to generate the first, second and third pulse width modulation signals such that the transfer ribbon is stationary during each print by the indirect thermal printer.

17. The system of claim 16 wherein the pulse width modulation generator is further configured to generate the first, second and third pulse width modulation signals such that the printhead is partially retracted during an acceleration of the supply roll and the take up roll after completion of each print and fully retracted when the acceleration is stopped.

18. The system of claim 17 wherein the web of thermally sensitive label stock is stationary during each print to the print area.

19. The system of claim 18 wherein the web of thermally sensitive label stock is in motion relative to the print ribbon between prints while the ribbon is under tension.

20. The system of claim 19 wherein the print area is a rectangular area defined by the adhesive.
